(19) United States
(12) Patent Application Publication
(10) Pub. No.: US 2015/0046283 A1
(43) Pub. Date: Feb. 12, 2015

(54) COMPUTERIZED SALES LEAD MANAGEMENT APPARATUS AND METHOD

(71) Applicant: LEADAMP, INC., Kaysville, UT (US)

(72) Inventors: Michael L. Bargeron, Farmington, UT (US); Kurt D. Black, Layton, UT (US); J. Stephen Savage, JR., Kaysville, UT (US)

(21) Appl. No.: 14/457,205

(22) Filed: Aug. 12, 2014

Related U.S. Application Data
(60) Provisional application No. 61/864,908, filed on Aug. 12, 2013.

(51) Int. Cl. G06Q 30/02; G06Q 30/06

(52) U.S. Cl. CPC G06Q 30/0201; G06Q 30/0633
USPC 705/26.8

(57) ABSTRACT

The system software facilitates and enables communication and commerce between sales agents and multiple sales lead vendors. Multiple sales agents, whether individually or associated with a corporation or company, may communicate and interact with multiple sales lead vendors. Sales lead vendors offer or submit individual sales leads to any interested sales agent. Sales agents submit orders for sales leads to lead vendors. The system software coordinates and manages these transactions between a sales agent and multiple sales lead vendors. The system software also evaluates the sales leads prior to purchase by a sales agent.

### BACKGROUND

1. The Field of the Invention

This invention relates to computer software, and more particularly, to novel systems and methods for managing, evaluating and posting sales leads.

2. The Background Art

Sales leads in a variety of industries are provided by numerous, individual sales lead vendors. Sales leads vendors obtain and make available sales leads to other companies. For example, a sales lead vendor may obtain various leads associated with the automobile insurance industry. The sales lead vendor may then sell each lead to a company selling automobile insurance. The company selling automobile insurance can purchase each individual lead from the sales lead vendor and the company selling automobile insurance may or may not have a computerized system in place for managing and evaluating those leads. However, sales lead software directed toward managing and evaluating sales leads is currently directed toward one, individual sales lead vendor.

It would be an advance in the art to develop a system and method whereby computer systems can collect data, analyze inputs, render decisions, and manage sales lead information from and between multiple sales lead vendors.

A company in communication with a sales lead vendor places an order for individual sales leads with each individual sales lead vendor. These orders for sales leads may include information such as the type of sales lead desired by the company placing the order and the area of the country from which the company desires to obtain sales leads. For example, a company selling automobile insurance may place an order for sales leads associated with the automobile insurance industry with a vendor capable of providing such leads. This order may include a request for sales leads associated specifically with “high risk” drivers within the state of New York. This order is not capable of being edited or amended. If the company selling automobile insurance desired to change the parameters of the order in any way, that company would have to place a new, separate order.

It would be an advance in the art to develop a system and method whereby lead management computer systems can allow various parameters of orders placed with single or multiple sales lead vendors to be edited or amended without having to place a new, separate order with the sales lead vendor.

A sales lead vendor uses a limited number of means for delivering sales leads to a customer or agent. It would be an advance in the art to allow sales leads to be delivered to a customer or agent via a number of means, including without limitation, electronic mail, text messages, phone calls, social media notifications, or the like.

### BRIEF SUMMARY OF THE INVENTION

In view of the foregoing, in accordance with the invention as embodied and broadly described herein, a method and apparatus are disclosed in one embodiment of the present invention as including a network computer system operative over the internet for receiving, evaluating, and managing sales lead information between multiple vendors for individual or multiple users or agents.

In certain embodiments, a client, user or agent may place one or more orders with a single sales lead vendor, or with multiple sales lead vendors such that a single order can be used to obtain sales lead information from multiple vendors. Accordingly, clients, users or agents can evaluate and purchase sales leads from multiple vendors without having to place a number of separate orders with each individual sales lead vendor. Thus, sales lead vendors will also be required to provide better services to sales lead clients as a result of the more direct and immediate competition between sales lead vendors.

In certain embodiments, the various parameters of any order placed by a user or agent may be edited or amended at the discretion of the user or agent. Accordingly, users or agents can edit or modify one or more parameters of an individual order and be able to better control and adjust the sales leads obtained from all sales lead vendors. Thus, the amount of information and timing associated with sales lead acquisition can be more easily and quickly adjusted to meet the individual requirements and preferences for each user or agent.

In certain embodiments, the disposition of an individual sales lead can be provided, monitored, or maintained by the user or agent. Accordingly, agents can track and monitor individual sales leads in the same manner and with the same system as where the agent requests and evaluates sales leads. Also, various methods for reporting or monitoring sales leads can be provided. Thus, the user or agent is able to manage its sales lead activities in one convenient system. The user or agent can also manage its sales lead information in a manner that is preferred or convenient for that individual.

In certain embodiments, the notification or posting of sales leads can be controlled by a user or agent. The user or agent can use a variety of methods to receive notification of sales leads in a manner, or multiple manners, that is convenient for that individual user or agent.

In general, the time it takes for a sales lead that has been generated to get from the sales lead vendor to the user or agent seeking such a sales lead is critical. Thus, the facilitation of the process of getting qualified sales leads from the sales lead vendor to the user or agent is critical. However, the proper evaluation of sales leads offered is also important. The current software system facilitates all the structures and methods necessary to achieve the fastest acquisition of sales leads by users or agents from the widest range of sales lead vendors. The current software system also ensures that the sales leads delivered to the users or agents are evaluated to be of the highest quality.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through the use of the accompanying drawings in which:

FIG. 1 is a schematic block diagram of a hardware suite for implementing an apparatus and method in accordance with the invention;

FIG. 2 is a schematic block diagram of an Internet and cloud-based system for implementing a method in accordance with the invention;

FIG. 3 is a schematic block diagram of communication processes between sales lead vendors, a lead management system, and sales lead clients;

FIG. 4 is a schematic block diagram of software modules in the memory of a computer system in accordance with the invention in order to execute the functionality in accordance with a sales lead management and evaluation system;

FIG. 5 is a schematic block diagram of a sales lead order;

FIG. 6 is a diagram of a sales lead order table;

FIG. 7 is a schematic block diagram flow-chart of a sales lead evaluation process associated with the system;

FIG. 8 is a schematic block diagram of a sales lead dispute resolution process associated with the system;

FIG. 9 is a diagram of a sales lead table; and

FIG. 10 is a schematic block diagram of a reporting module in accordance with a sales lead management and evaluation system.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated with like numerals throughout.

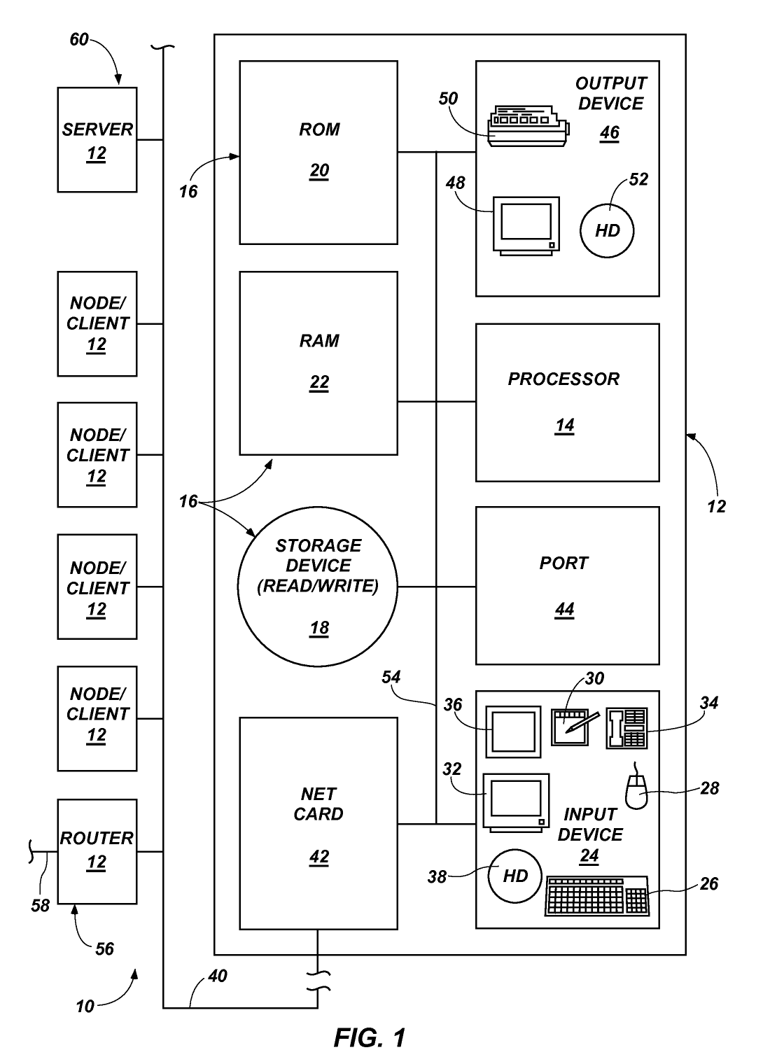

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a use or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a use, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In selected embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably connect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In selected embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

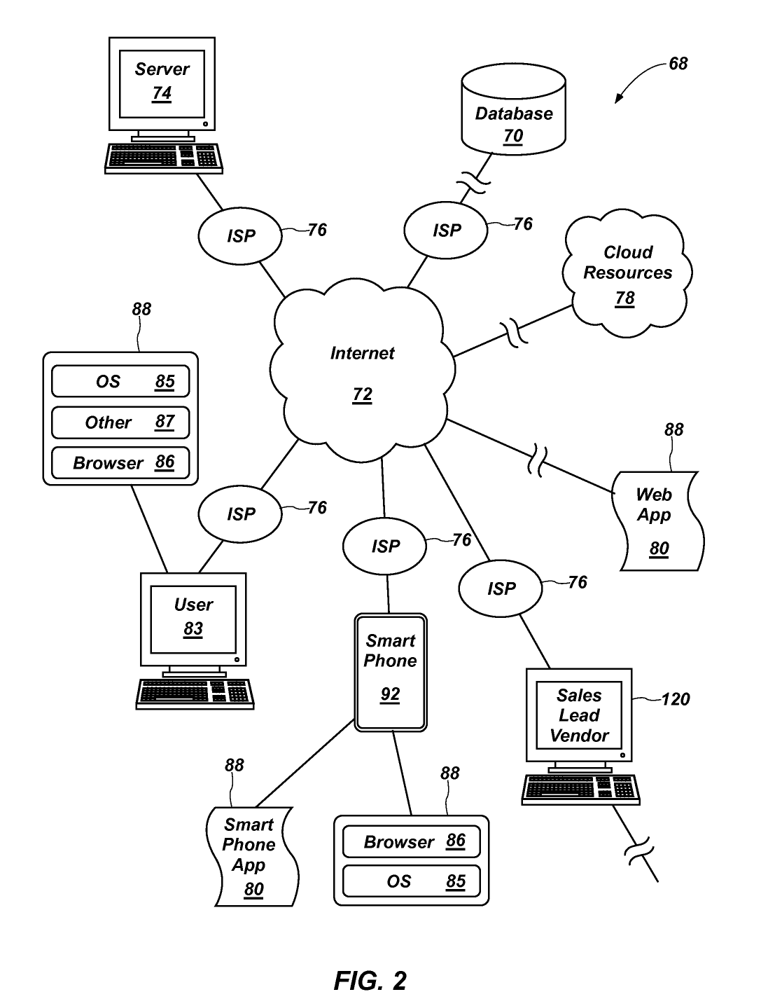

Referring to FIG. 2, a system 68 may include a database 70 for containing information. The information may relate to all the data required to order, evaluate, and manage sales leads. Typically, a database 70 may connect to the internet 72 in order to access or be accessible by servers 74. Each networked device owned by any entity, including the computer or computers hosting database 70 and the server 74, may connect to the internet 72 through an internet service provider 76 or ISP 76.

As a practical matter, servers 74 are not necessarily dedicated, full-time-on-line systems owned by a single entity. In view of the fact that many cloud resources 78 exist, including such items as servers 74, storage 70, and the like, services may be provided for the database 70, the server 74, the web application 80, or the like, by way of cloud resources 78.

Cloud resources constitute any combination of processors, software, storage, and access at will on a virtual basis rather than on a dedicated basis. The virtual resources exist, but connected only as virtual elements on demand, and therefore are freed up when not needed, for use by other users. Thus, one may think of cloud resources 78 as representing infrastructure, hardware, software, and the like, accessible to users over the internet 72 at some service cost, rather than by dedicated ownership and maintenance by a single user or entity.

In the illustrated embodiment, the resources served up by the server 74 may be delivered through a web application 80 that provides web pages for browsing by users. For example, a user may access a web page through a browser 86 as part of user interface software 88. The user interface software may include an operating system 85 on which the browser 86 operates. Similarly, other software 87 may operate on top of the operating system 85.

In the illustrated embodiment, a browser 86 may be launched from a computer of a user 82 connecting to the internet 72 through an ISP 76. In this embodiment, a user may rely on the browser 86 to operate a web application 80 available through cloud resources 78, such as a server 74, across the internet 72.

In other embodiments, a user may simply rely on a smart phone application 90 loaded on a smart phone 92, such as an Apple iPhone™, Android™, BlackBerry™, or the like. Similarly, within the scope of computational facilities, the tablet computers that operate like a user computer 82, and yet have minimal requirements on bandwidth and operating systems, similar to smart phones 92, may also be used. Thus, by smart phone 92 examples included herein are meant any personal computing device that is internet enabled through an ISP 76 to access the internet 72.

For example, in addition to a smart phone application 90, a smart phone 92 may also host a browser 86. One benefit of an application 90 is that it may be dedicated and personalized, and do many tasks that a user desires, which are particular to the web application 80 that is to be run. In fact, many of the tasks of the web application 80 may actually be off loaded to the smart phone application 90. In other embodiments, the smart phone application 90 may simply be a very intelligent and highly programmed browser 86 that accesses resources from the database 70, the server 74, or the web application 80. In general, however, a browser 86 will typically be generalized, and will require a user to navigate on the browser 86 by way of the screen of a smart phone 92 in order to find a web server 74 or web application 80 that treats the browser 86 as a user at arms length.

In contrast, the smart phone application 90 may be customized, may be dedicated to both the functionality of the web application 80, and may even replace the web application 80, in order to deal with the database 70 directly, the server 74 directly, or the like.

Under this general proposition, the functionality of an application 80 may operate to order, evaluate, and manage sales leads. For example, all of the functionality of the server 74 may be available in a web application 80. In fact, the web application 80 may actually be hosted on a server 74. However, it may be hosted on some other cloud resources 78.

Likewise, the database 70 typically will store formats and content that will be assembled by the web application 80 in order to make presentations to a user.

Thus, in general, one may think of the application 80 as being the functionality in software, regardless of how and where that software is hosted. Indeed some or all of that software may be hosted in a smart phone application 90, on an application on a server 74 or elsewhere.

In selected embodiments, the user computer 82 may provide inputs, including various parameters for a sales lead order so that the user 82 may obtain sales lead information. Accordingly, the mode for obtaining sales leads, as well as information associated with sales leads, may shift from a system where a user is required to place a separate and distinct order for sales leads with one sales lead vendor to a system where a user may place a single order for sales leads with one or multiple sales lead vendors.

Once a system allows a user 82 to place a single order for sales leads with multiple sales lead vendors, then an individual sales lead vendor 120, or sales lead vendor computer 120, can continue to sell sales leads to user 82, but the more direct competition between individual sales lead vendors 120 may result in better pricing for sales leads, which pricing may be set according to accuracy, relevance, and potential associated with sales leads from respective individual sales lead vendors. Thus, although the web application 80 and all the similar embodiments discussed above may continue to sell sales leads, they may now have a lower price.

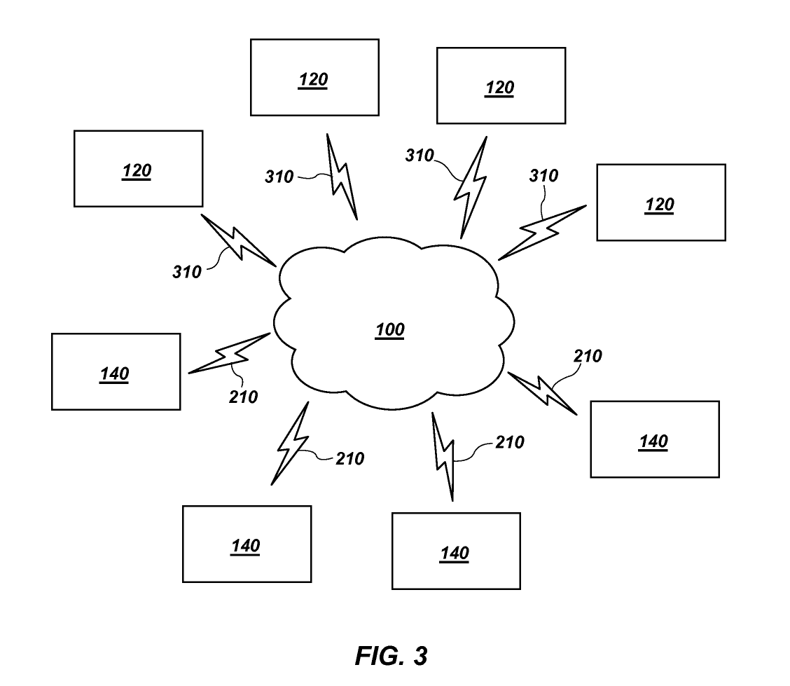

Referring to FIG. 3, in one embodiment of an apparatus and method in accordance with the invention, the system software 100, or lead management software 100, may include various software modules stored in memory 14. In accordance with the foregoing information above, the memory 14 may be distributed in any number of locations, including cloud resources 78, the database 70, the server 74, or elsewhere.

In one embodiment, a data base engine may provide services for getting information in and out of the data base 70, sorted, filtered, indexed, and so forth. A data base engine may be a content management system such as PyroCMS™, or the like. Likewise, records may be stored in the data base 70 and correspond to various entities. For example, users or sales lead agents 140, or user or sales lead client orders 210 may be stored. Also, sales lead vendors 120, or sales leads 310 may be stored. Likewise, other data records including for various order parameters, such as the type of lead, the number of leads, and the area for leads may be stored. Likewise, other data records for various lead and lead evaluation, such as lead information, lead dispute resolution, and lead disposition may be stored. These concepts will be discussed in more detail.

A sales lead vendor 120 may refer to any entity that offers sales leads 310 in any industry. A user or agent 140 may refer to an individual or a corporation/company employing multiple sales agents. Generally, a user or agent 140 is any entity that places an order 210 for sales leads 310.

The system software 100 facilitates and enables communication and commerce between a user or agent 140 and multiple lead vendors 120. Similarly, multiple users or agents 140 associated with a single corporation or company may communicate with multiple lead vendors 120. Generally, lead vendors 120 offer or submit individual sales leads 310 to any interested user or agent 140. Users or agents 140 submit orders 210 for sales leads 310 to lead vendors 120. The system software 100 coordinates and manages these transactions so a single user or vendor 140 may submit a single order 210 that may obtain sales leads 310 from multiple lead vendors 120.

Previously, a user or agent 140 was required to submit a separate order 210 for sales leads 310 to each individual lead vendor 120.

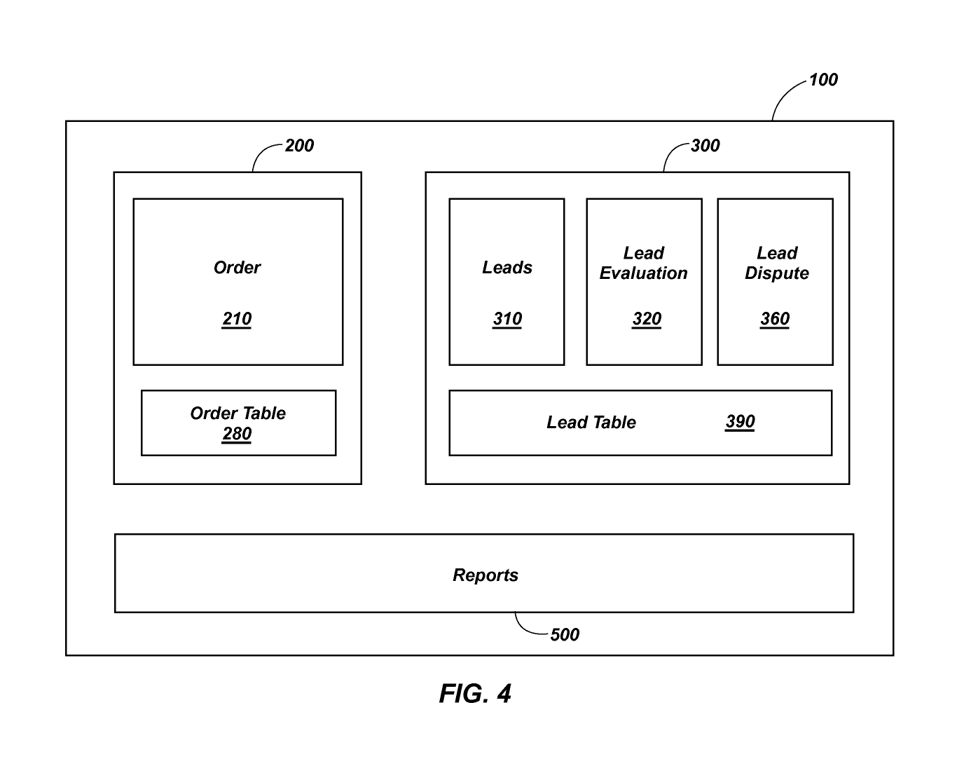

Referring to FIG. 4, in one embodiment of an apparatus and method in accordance with the invention, the system software 100, or sales lead management software 100, may include a software module for lead orders 200, a software module for sales leads 300, and a software module for reports 500. The system software 100 may also include other software modules for providing a variety of functions, as well as maintaining, interconnecting, and backing up the various, other software modules.

The software module for lead orders 200, or simply order module 200, may include sales lead orders 210, including the various parameters that can be included and associated with each sales lead order 210, and an order table 280 for managing, monitoring, viewing, correlating, tracking and editing individual sales lead orders 210.

The software module for sales leads 300, or simply lead module 300, may include individual leads 310, including information related to individual leads 310, lead evaluation 320, lead dispute submission and resolution 360, and a lead table 390 for managing, monitoring, viewing, correlating, and tracking the status and disposition of individual leads 310.

The software module for reports 500 or reporting 500, or simply report module 500, may include various methods and manners for comparing, tracking, and evaluating information and results related to numerous facets of the system software 100, including without limitation: individuals user or agents 140, groups of users or agents 140, individual sales lead vendors 120, groups of sales lead vendors 120, individual sales leads 310, groups of sales leads 310, geographical areas from where sales leads are obtained, sales lead 310 rejection or acceptance rates from sales lead vendors 120, sales lead 310 dispute submissions and resolutions from sales lead vendors 120, comparisons of past and present performance for sales lead 310 acquisition from sales lead vendors 120, comparisons of past and present performance for sales lead 310 types in various industries, comparisons of past and present performance for individual users or agents 140, and various combinations of these parameters.

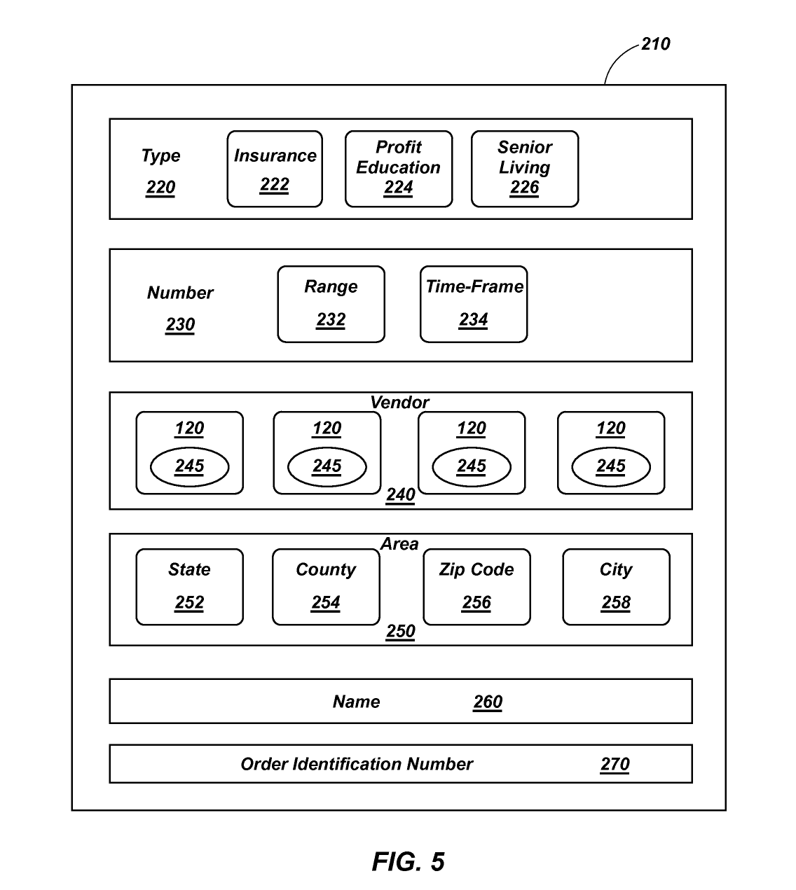

Referring to FIG. 5, an individual sales lead order 210, or simply order 210, may include numerous parameters. A user or agent 140 placing an order 210 for sales leads 310 will generally include at least the following information: the type of sales lead 220 desired, or simply type 220; the number of sales leads 230 desired, or simply number 230; the sales lead vendor designation 240, which may include multiple sales lead vendors 120; and the geographical area 250 from which sales leads 310 are desired.

A user or agent 140 placing an order 210 will generally include a designation of the type 220, or types 220, of sales lead 310 desired. For example, the types 220 of sales leads available may include insurance 222 sales leads, profit education 224 sales leads, senior living 226 sales leads, and a virtually limitless number or other types 220 of sales leads available from virtually any industry. Moreover, these individual types 220 of sales leads 310 may include further categories to allow for ordering 210 specific types of leads within an industry. For example, insurance 222 sales leads 310 may be further categorized into auto insurance, home insurance, or life insurance. Additionally, insurance 222 sales leads 310 associated with auto insurance may be further categorized into high-risk, normal, etc.

Generally, a sales lead vendor 120 will specify which types 220 of sales leads 310 that vendor 120 offers in any given industry and at what price 245. The user or agent 140 may then choose from any of these types 220 when placing an order 210 through the system software 100. The system software 100, or software module for lead orders 200, may provide any categories, sub-categories, etc., that may be necessary for each type 220 of sales lead 310 associated with any industry. Accordingly, the system software 100, or order module 200, may provide a user or agent 140 the ability to choose from a large variety of sales leads 310. Thus, the user or agent 140 selects the type 220, or types 220, of sales leads 310 associated with an order 210.

The system software 100, or order module 200, may include a campaign. The campaign may be described as a master list of all types 220 of sales leads that are available from each respective lead vendor 120. Each lead vendor 120 may offer certain types 220 of sales leads 310. Thus, the campaign contains information regarding which lead vendor 120 offers which type 220 of sales leads 310 and the campaign may be used to assign type 220 of sales lead from each lead vendor 120 for each user or agent 140. Generally, the campaign is accessible only by a system administrator.

A user or agent 140 placing an order 210 will generally include a designation of the number 230 of sales leads 310 desired. For example, the number 230 of sales leads 310 an individual user or agent 140 may desire can range 232 from 1-50, or any number desired by the user or agent 140. Also, an individual user or agent 140 may select the number 230 of sales leads 310 to be obtained over a selected time-frame 234, such as daily, weekly, or monthly. Once the selected number 230 of sales leads 310 is delivered to the user or agent 140, the system software 100 will not deliver any additional sales leads 310 until the time-frame 234 associated with the number 230 has ended or been reset.

As will be shown, each sales lead 310 goes through an evaluation process before it is delivered to the user or agent 140. A sales lead 310 is delivered to the user or agent 140 as soon as it is approved by the evaluation process. It is possible that a first sales lead may enter the evaluation process before a second sales lead, but the second sales lead is approved before the first sales lead. In such a situation, the second sales lead is delivered to the user or agent 140 before the first sales lead. Additionally, if this second sales lead is considered the final sales lead that satisfies the number 230 associated with the order 210, then the first sales leads is not delivered to the user or agent 140. However, a user or agent 140 may choose to have all sales leads that enter the evaluation process within the given time-frame 234, and are approved through the evaluation process, delivered. The system software 100 can accommodate the user or agent 140 preference.

A user or agent 140 placing an order 210 will generally include a designation of the vendor 240, or vendor designation 240, which may include multiple individual vendors 120, from which sales leads 310 are desired. For example, once a type 220, or types 220, of sales lead 310 is selected, the individual sales lead vendors 120 offering that type 220 of sales lead 310 are made available for selection by the user or agent 140. As noted previously, each individual sales lead vendor 120 sets a price 245 for each sales lead actually delivered to the system software 100, and then to the user or agent 140. The individual sales lead vendors 120 are listed with their corresponding price 245 for each sales lead 310. Thus, the user or agent 140 selects the vendor designation 240, including multiple vendors 120 and associated price 245, associated with an order 210.

The system software 100, or order module 200, may include a source list. The source list may be described as a master list of all lead vendors 120. Each lead vendor 120 may offer certain types 220 of sales leads 310 at a price 245 selected by the vendor 120. The source list contains information regarding which lead vendor 120 offers which type 220 of sales leads 310. The source list may be used to assign lead vendors 120 to users or agents 140, or corporations or companies having more than one agent so that each user or agent 140 can select appropriate lead vendors 120. Generally, the source list is accessible only by a system administrator.

The system software 100, or order module 200, may include a pricing list. The pricing list may be described as a master list for the price 245 set for sales leads 310 from all lead vendors 120. Each lead vendor 120 may offer a certain price 245 for sales leads 310, including different prices for different types 220 of sales leads. The pricing parameters may be set and changed by each lead vendor 120. For example, a certain price 245 can be set for a certain type 220 of sales lead 310 over a specified range of dates, or for a specified volume or number 230, or any range of factors desired by the lead vendor 120. The pricing list contains information regarding the price 245 and pricing parameters which each lead vendor 120 offers with respect to each type 220 of sales leads 310. Thus, the pricing list may be used to assign prices 245 to each type 220 of sales lead 310 at the time the order 210 is submitted. Accordingly, the price 245 of a type 220 of sales lead 310 may change over a given period of time or over a given volume of sales leads purchased. Regardless, the system software 110, or order module 200, can facilitate automatic application of price changes on a system-wide basis. Generally, the pricing list is accessible only by a system administrator.

A user or agent 140 placing an order 210 will generally include a designation of the geographical area 250, which may be selected on various bases, from which sales leads 310 are desired. For example, the geographical area 250 may be selected by state 252, county 254, zip code 256, or city 258. Other geographical designations may also be available, such as phone number area codes. Thus, the user or agent 140 selects the geographical area 250 associated with an order 210.

The system software 100, or software module for lead orders 200, will eliminate duplicate geographical areas 250 regardless of how the area is selected. For example, if a user or agent 140 first selects Salt Lake City as part of the geographical area 250 and then further selects Salt Lake County as part of the geographical area 250, the remaining zip codes from Salt Lake County not already included from the designation of Salt Lake City will be added to the final geographical area 250 designation for the order 210. In other words, if a user or agent 140 selects two cities 258 and four zip codes 256 as the geographical area 250 for an order 210, a given sales lead 310 will only be delivered to the agent 140 once, even if that sales lead could be included within one of the two cities selected and an overlapping zip code. Thus, delivery of duplicate sales leads 310, and duplicate payment for the same sales lead, is avoided.

A user or agent 140 placing an order 210 may include a designation of a name 260 for each order 210. This feature is especially helpful if a user or agent 140 places multiple orders 210. The name 260 may be any designation of alpha-numeric characters selected by the agent 140.

An order 210 may be reviewed in summary form to allow a user or agent 140 to verify all the details of the order 210, and various order parameters, before the order 210 is actually placed.

Once an order 210 is placed, the system software 100, or software module for lead orders 200, assigns an order identification number 270 to each individual order 210. The order identification number 270 may be any designation of alpha-numeric characters assigned by the system software 100, but generally the order identification number 270 will be a numerical designation assigned to each order 210 in numerical order as submitted. The order identification number 270 provides a means whereby each order 210 may be monitored, tracked, or edited.

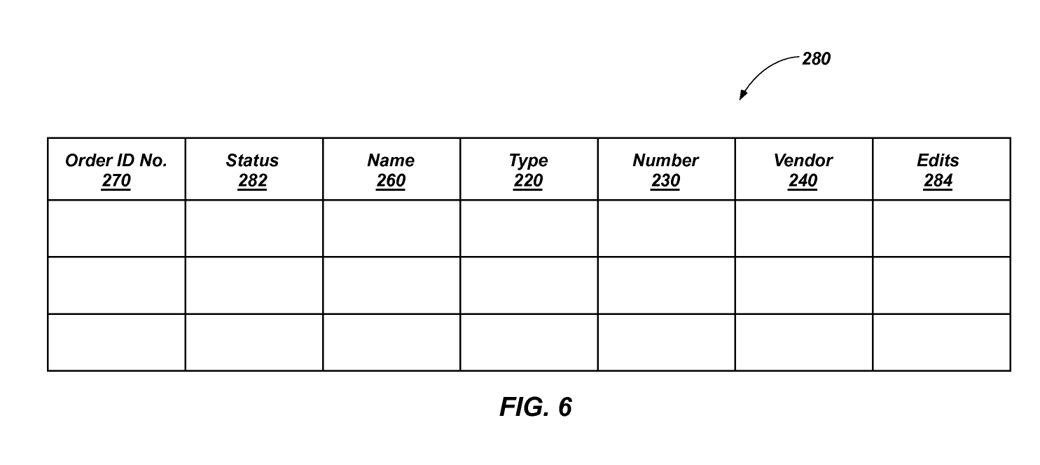

Referring to FIG. 6, an order table 280 may be generated by the system software 100, or order module 200, and displayed to a user or agent 140. Generally, an order table 280 displays each individual order 210 previously submitted by a user or agent 140. In one selected embodiment, the order table 280 displays various parameters for the order 210, including without limitation: the order identification number 270, the name 260 of the order 210, the type 220 of order 210, the number 230, and the vendor designation 240. Additionally, the order table 280 may include the ability to adjust the order 210 in a variety of ways, such as pausing the order 210 so that no additional sales leads 310 are delivered, canceling an order 210, or editing the parameters of a previously submitted order 210.

For example, a previously submitted order 210 may be paused at the direction of the user or agent 140, which will cease the delivery of any additional sales leads 310 regardless of whether the number 230 associated with the order 210 has been satisfied. The order status 282 may be designated on the order table 280 by a symbol or statement, or other appropriate designation, such as an “A” for active or a “P” for paused or an “R” for resumed, or a star symbol for active and two vertical bars for paused.

Similarly, a previously submitted order 210 may be canceled or deleted. An order 210 may be selected from the order table 280 and then canceled or deleted from the order table 280. A prompt may inquire whether the user or agent 140 intends to cancel or delete the order 210. Once an order 210 is canceled, a new order 210 may be generated in the same manner as described above, including a new order with the same parameters as the order previously deleted.

As a further example, a previously submitted order 210 may be selected from the order table 280. After selection of a specific order 210, the various parameters of the order 210 may be edited or changed in any manner allowed prior to the submission of the order 210, including without limitation, adjusting the number 230, type 220, vendor designation 240, geographical area 250, or even editing the name 260. Edits 284 and changes 284 to an order 210 may be displayed on the order table 280, generally including the last date the order 210 was edited or modified in any way. The specific details of edits 284 may also be displayed in a pop-up screen within the order table 280 when a user or agent 140 appropriately requests such details, such as by double-clicking or hovering over the edits 284 date on the order table 280.

Generally, a previously submitted order 210 will maintain its previously assigned order identification number 270 regardless of any edits 284, changes, or pauses to the order 210 made by the user or agent 140. This is done so the system software 100, or order module 200, may continually track and monitor each order 210. However, if a user or agent 140 would prefer that an edited order be assigned a new order identification number 270 after edits are made, this preference can be accommodated.

The lead module 300 (FIG. 4) may include individual sales leads 310, evaluation 320 of sales leads 310, dispute submission and resolution 360, and a lead table 390.

Individual sales leads 310 are initially generated by individual sales lead vendors 120. The sales lead vendors 120 make those leads available to users or agents 140. A sales lead 310 may include a variety of information, generally including contact information and background information. For example, a sales lead 310 may include a person's name, address, phone number, and e-mail address, as well as information regarding that person's age, gender, shopping or purchase interests, purchase history, driving record, credit scores, and other available information. This information may be generally distinguished as between lead information 400, or more general information, and lead payload 410, or more specific information.

Generally, a user or agent 140 is allowed to review and evaluate lead information 400 before purchasing the sales lead 310 from the lead vendor 120. After purchasing a sales lead 310, the user or agent 140 may be provided all available information for that sales lead, including lead information 400 and, if available, a lead payload 410.

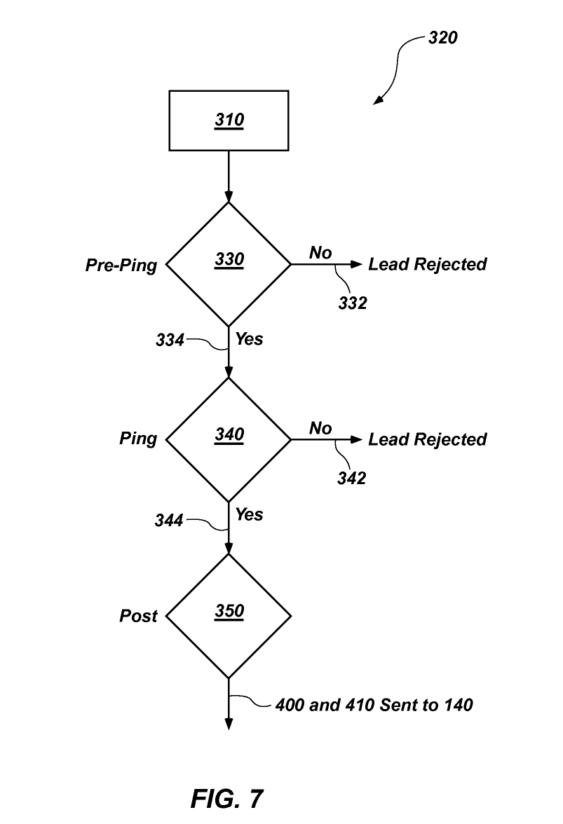

Referring to FIG. 7, a lead evaluation process 320 may be implemented to allow the system software 100, or lead module 300, to evaluate the lead information 400 for a sales lead 310 before a user or agent 140 purchases that sales lead 310. In one selected embodiment, a series of tests is performed comparing and analyzing the lead information 400 with existing orders 210 to help ensure that a sales lead 310 purchased by a user or agent 140 will meet that agent's criteria and standards.

For example, an individual sales lead 310 enters the evaluation process 320 and the system software 100, or lead module 300, performs what may be termed a “pre-ping” 330 analysis of the lead information 400. A pre-ping 330 analysis confirms that preliminary order 210 parameters are met by the sales lead 310, including without limitation, a user or agent 140 has placed an order 210 requesting this type 220 of sales lead 310 within the appropriate geographical area 250 from at least one vendor 120 within the vendor designation 240. If the offered sales lead 310 does not meet all of these criteria from the pre-ping 330, the sales lead 310 is rejected 332. If the offered sales lead 310 meets all of these criteria from the pre-ping 330, the sales lead 310 proceeds 334 to the next stage of the evaluation process 320. The next stage of the evaluation process 320 may be termed a “ping” 340.

The number of criteria associated with the pre-ping 330 may be varied, but generally, the pre-ping 330 is intended to be a relatively quick and initial verification of a proposed sales lead 310. As will be shown, the ping 340 is a little more detailed analysis requiring additional time and resources. The pre-ping 330 can be performed relatively quickly and easily and determines whether the additional time and resources required for the ping 340 are warranted. It should be noted that not every sales lead vendor 120 enables its available lead information 400 to be utilized for a pre-ping 330. However, many vendors 120 do enable a pre-ping 330 analysis.

A ping 340 analysis may include confirming and analyzing all information available in the lead information 400. For example, a name associated with a sales lead 310 in the lead information 400 may be evaluated to eliminate any sales leads 310 with apparently incorrect names. This may be done by comparing the name to a list of names known to be commonly attributed to fictional characters, i.e., Mickey Mouse™, Bugs Bunny™, or the like. Likewise, an address may be verified by comparison with a postal service database of existing addresses, or Google™, or the like. Likewise, an e-mail address may be verified as being in the proper format for an e-mail address with a valid domain. Likewise, a telephone number may be verified as having the appropriate number of digits with a valid area code. These checks and verifications can be configurable so as to be able to verify common attributes of virtually any piece of information. Such configurations can be implemented within the system software 100, or lead module 300, by a system administrator independently or at the request of a user or agent 140.

A ping 340 analysis may include confirming that no duplicate sales leads 310 are delivered to a user or agent 140 during a designated number 230, including within the designated time-frame 234. This may be accomplished by comparing the sales lead 310 being evaluated 320 with sales leads 310 already delivered to that agent. Thus, a user or agent 140 will not receive the same sales lead 310 during the course of an order's 210 number 230, however, that user or agent 140 may receive the same sales lead 310 after the resetting of an order's 210 number 230.

A ping 340 may include “model scoring” from a user or agent 140. Generally, model scoring may be described as a statistical, weighted analysis to evaluate proposed sales leads 310 based on the available lead information 400. The sales lead 310 and lead information 400 is compared to the model scoring. If the sales lead 310 does not meet a minimum criteria score based on the comparison with the model scoring, the sales lead 310 is rejected 342.

The model scoring parameters for a specific user or agent 140 are generally considered proprietary information. As can be seen, the model scoring may be highly specialized for a specific user or agent and for a specific industry. The system software 100, or lead module 300, is capable of incorporating the model scoring from a user or agent 140 into the ping 340 analysis.

A ping 340 analysis may include an order matching verification. The order matching comparison may be similar to a pre-ping 330 analysis, but may also include more detail. The order matching verification may be considered a final step in the ping 340 analysis just prior to purchasing and posting 350, or simply post 350, of the sales lead 310 to the user or agent 140. As can be seen, the evaluation process 320 takes a certain amount of time to complete and can vary markedly depending on the sales lead 310, lead information 400, and available of verification and analysis sources. The order matching verification is done at the end of the ping 340 analysis to ensure that a current order 210 is still requesting sales leads 310 that have completed the evaluation process 320.

While other ping analyses may be available, the disclosed ping 340 analysis may be considered the most comprehensive and complete ping 340 analysis available. If the offered sales lead 310 does not meet all of these criteria from the ping 340, the sales lead 310 is rejected 342. If the offered sales lead 310 meets all of these criteria from the ping 340, the sales lead 310 proceeds 344 to the next stage of the evaluation process 320. The next stage of the evaluation process 320 may be termed a “post” 350, or notifying or posting.

The post 350 of a sales lead 310 may include the actual purchase of the sales lead 310 from a vendor 120 at the agreed price 245. The post 350 may include sending the sales lead 310, as well as lead information 400 and any available payload 410, to the user or agent 140. The post 350 may be accomplished by a variety of means including, addition of the sales lead 310 to the lead table 390, e-mail directly to the user or agent 140, text message directly to the user or agent 140, notification via social media outlets (e.g., Twitter™), or the like.

Also, once a sales lead 310 is posted 350, the sales lead 310 is assigned a lead identification number 392 by the system software 100, or lead module 300. The system software 100, or lead module 300, may include tracking, monitoring, and correlating of sales leads 310 in a lead table 390, which can be accomplished with the assistance of the lead identification number 392. The lead identification number 392 may be any combination of alpha-numeric characters, but a newly posted 350 sales lead 310 is generally assigned a number in numerical order of posting.

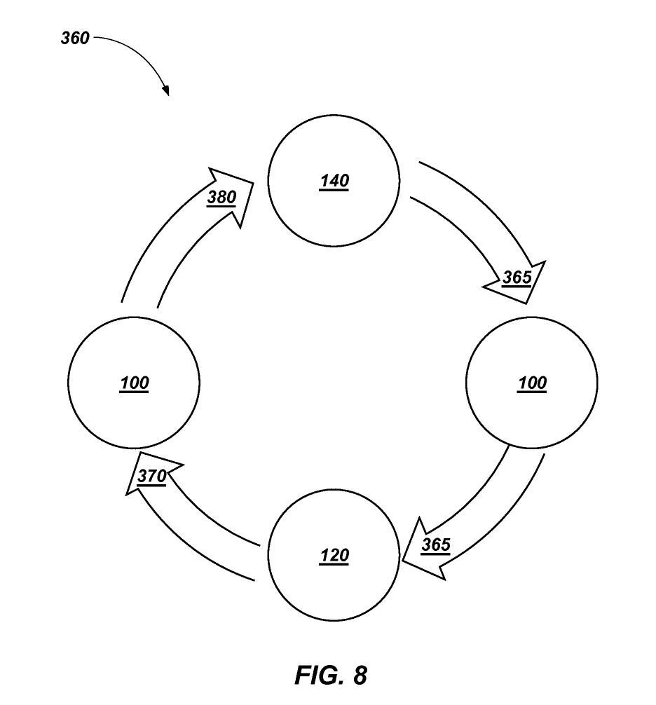

Referring to FIG. 8, a lead dispute submission and resolution process 360, or simply dispute process 360, may be included in the system software 100, or lead module 300. A user or agent 140 may discover a problem or error with a sales lead 310 or its lead information 400. The user or agent may initiate a dispute with the lead vendor 120 that provided the disputed sales lead 310. The user or agent 140 will dispute 360 the sales lead 310 on a dispute basis 365.

A dispute basis 365 is generally determined by each lead vendor 120 and may include incorrect phone number, or the like. For example, a dispute based on an incorrect phone number may arise if a user or agent 140 calls the phone number provided with a sales lead 310 having the name John Smith and asks to speak with Mr. John Smith, but the response is that no John Smith is available at that phone number, or the phone number is for a business.

The user or agent 140 may then submit the sales lead 310 to the dispute process 360 by indicating the dispute basis 365 to the appropriate lead vendor 120 through the system software 100, or lead module 300. The lead vendor 120 may then evaluate or consider 370 the dispute basis 365. After the lead vendor 120 has determined a dispute result 380, the lead vendor 120 may communicate that dispute result 380 to the user or client 140 through the system software 100, or lead module 300. Once a dispute result 380 is determined and communicated, appropriate refunds or credits can be determined accordingly.

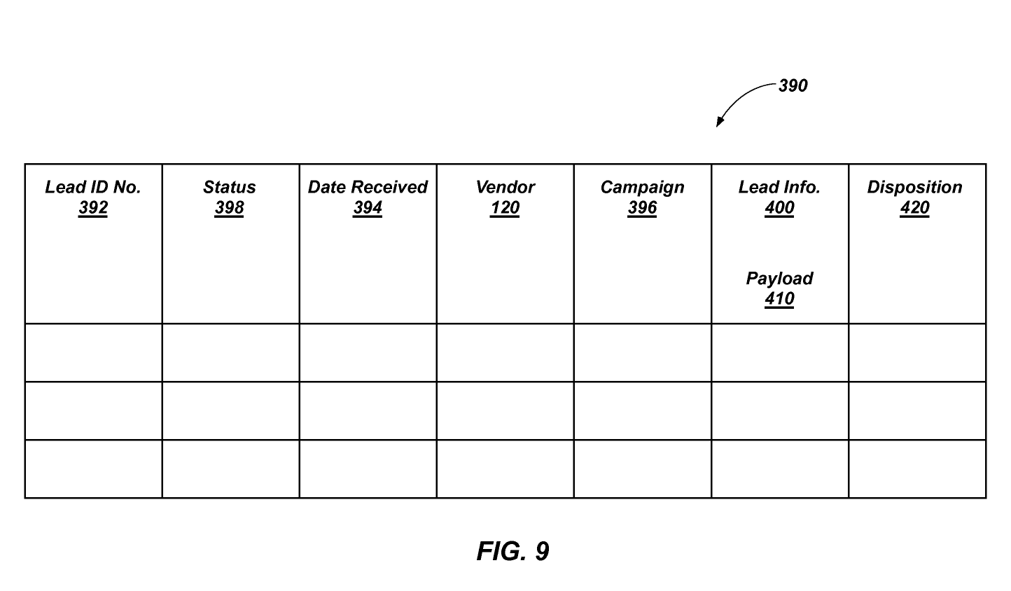

Referring to FIG. 9, a lead table 390 may be generated by the system software 100, or lead module 300, and displayed to a user or agent 140. Generally, a lead table 390 displays each individual sales lead 310 previously posted 350 to a user or agent 140. In one selected embodiment, the lead table 390 displays various information associated with the sales lead 310, including without limitation: the lead identification number 392; the date 394 the lead 310 was posted 350, which may include the specific time of the day; the lead vendor 120 from which the sales lead 310 was obtained; the type 220, which may include and/or be designated as a campaign 396; the lead information 400, including, if available, lead payload 410; and the lead disposition 420. Additionally, the lead table 390 may include the dispute status 398 for a sales lead 310 that is or was subject to the dispute process 360.

For example, the dispute status 398 may be designated on the lead table 390 by a symbol or statement, or other appropriate designation, such as an “S” for submitted or a “C” for considering or a “Y” for a positive result or an “N” for a negative result, or a plus or minus symbol for a positive or negative result 380, and an hourglass symbol for a dispute still being considered 370.

Another benefit of the system software 100, or lead module 300, is that because multiple lead vendors 120 can be in communication through the system software 100, or lead module 300, a user or agent 140 can submit disputes over sales leads to the appropriate lead vendor 140 from a single resource. Previously, a dispute over an individual sales lead had to be submitted directly to the appropriate lead vendor 120. If a user or agent 140 wanted to dispute multiple sales leads, that user or agent had to contact each lead vendor 120 separately.

The lead information 400 may displayed on the lead table 390, or on a pop-up screen activated when the user or agent 140 double-clicks or hovers over the lead information 400. For example, the lead information 400 (i.e., name, phone number, email address, etc.) may be displayed on the lead table 390, but the lead payload 410 (i.e., age, gender, driving history, etc.) may be made available after the user or agent 140 double-clicks on certain lead information 400 or an icon indicating the presence of lead payload 410.

The lead disposition 420 may be displayed on the lead table 390, or on a pop-up screen activated when the user or agent 140 double-clicks or hovers over the lead disposition 420. The lead disposition 420 enables the user or agent 140 to track and monitor the status of the sales lead with respect to a possible sale or future contact. For example, categories of lead disposition 420 designations may be made available and may include: sale completed, requested additional information, called but no answer, left a voice message, e-mailed sales information, no interest, etc. Similarly, lead disposition 420 and related notes may be entered by the user or agent 140.

The ability to include lead disposition 420 with lead management software, such as the system software 100, is a feature not previously available. This may be considered an especially useful feature for users and agents 140 because it allows for the management, monitoring, ordering, disputing, and tracking of multiple sales leads 310 from multiple sales vendors 120 from a single resource, the system software 100.

Generally, a posted 350 sales lead 310 will maintain its previously assigned lead identification number 392 regardless of any dispute result 380. This is done so the system software 100, or lead module 300, may continually track and monitor each sales lead 310. However, if a user or agent 140 would prefer that a disputed lead be assigned a new lead identification number 392 after a sales lead 310 is submitted to the dispute process 360, this preference can be accommodated.

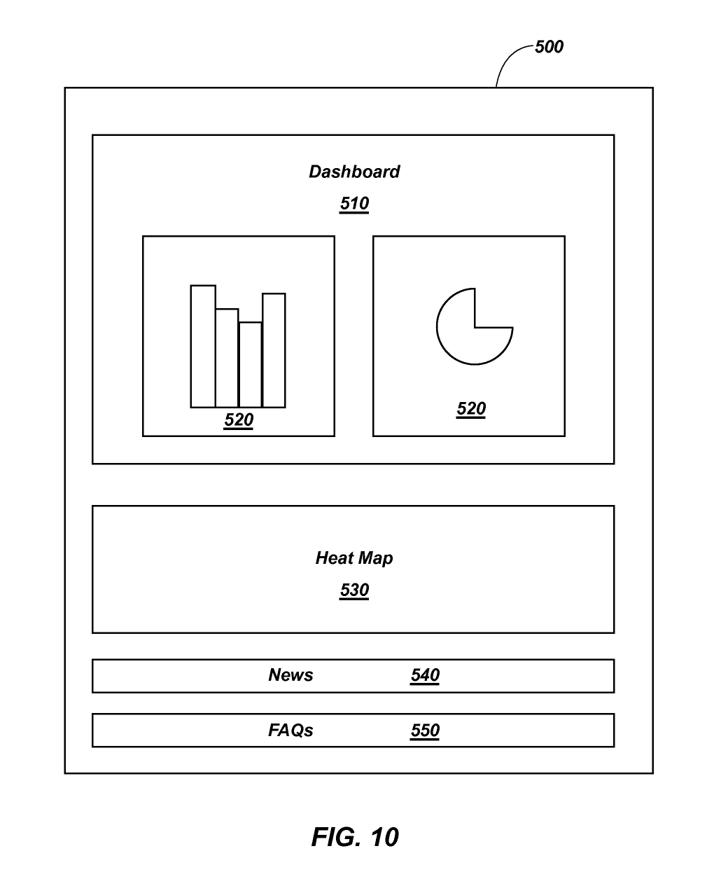

Referring to FIG. 10, the report module 500 may include a dashboard 510, a heat map 530, news 540 or recent announcements 540, and frequently asked questions, or FAQs 550.

A dashboard 510 is primarily intended to allow for comparison of multiple aspects of the information available from the system software 100. A dashboard 510 may be beneficial to groups of users or agents 140 working with or for the same company, or supervising personnel overseeing users or agents 140. The dashboard 510 may show trends in users or agents 140, sales leads 310, lead vendors 120, the evaluation process 320, the dispute process 360, etc. Accordingly, virtually limitless configurations for a dashboard 510 are possible depending on how information is intended to be compared.

For example, a graph 520 may show the number of sales leads a particular user or agent 140 obtains from the various lead vendors 120 offering a type 220 of sales leads over a given month. This data may be compared to similar data from the same month of a previous year or years. This data may also be broken down by sales leads that resulted in a successful sale.

As another example, a graph 520 may show the total number of sales leads 310 of a certain type 220 offered by a lead vendor 120 and compare that with the number of those sales leads that are accepted after the evaluation process 320. This comparison may be termed as comparing qualified leads to disqualified leads. Again, this data may be set over a given period of time, such as weekly or monthly, and compared to previous, similar periods.

As another example, a graph 520 or chart 520 may show the amount of money spent purchasing sales leads from a particular lead vendor 120, or group of vendors 240, and compare that with the amount of money generated from successful sales resulting from those sales leads. Again, this data may be set over a given period of time, such as quarterly or yearly, and compared to previous, similar periods.

From these examples, it can be seen that numerous comparisons and configurations for comparisons can be accommodated by the system software 100, or results module 500. Virtually any comparison of any of the data available in the system software 100 can be provided at the request of a user or agent 140, or company.

A heat map 530 may be included to show volumes of sales leads 310 by geographical area 250. A heat map 530 may show the volume of leads obtained over a given area, such as a state 252, county 254, channel, or lead credit. A channel heat map may include volume of sales leads for all users or agents 140, and further distinguish between users or agents 140 operating from the field or from a call center. A lead credit heat map may include a comparison of leads credited to a user or agent 140 or company after a dispute process 360 and further distinguished by channel. As can be seen specific heat map 530 reports can be developed or configured according to agent or company preferences.

A news article 540 or announcement 540 may be included to alert all users or agents 140 associated with a specific company of any important developments in their relevant industry or within their respective company.

FAQs 550, along with the answers, may be included to provide some easy-access training or help for users or agents 140. The subjects for the FAQs 550 may include: customer relations issues, system software operation issues, etc.

Generally, the time it takes for a sales lead 310 that has been generated to get from the sales lead vendor 120 to the user or agent 140 is critical. As has been shown, the system software 100 allows a user or agent 140 to place a single order 210 with multiple lead vendors 120. Also, the lead evaluation process 320 provides a thorough analysis of each sales lead 310 while not consuming considerable time between offering of the sales lead 310 by the lead vendor 120 and posting 350 the sales lead 310 to the user or agent 140. Generally, the goal for the amount of time taken between when a lead vendor 120 offers a sales lead 310 and when that sales lead 310 is posted 350 to appropriate, interested users or agents 140 is approximately two (2) minutes. This may described as the intended posting time. Various factors can influence this intended posting time.

For example, the time it takes for the system software 100, or lead module 300, to complete the evaluation process 320 may be lengthened or delayed if a third-party system is not operating as expected, such as a postal service address verification system not being available at a given time. Also, a sales lead 310 that is delayed for too long in the evaluation process 320 may be considered stale after a certain period of time (i.e., 30 minutes) and discarded or rejected.

The current software system facilitates all the structures and methods necessary to achieve the fastest intended posting time available.

The present invention may be embodied in specific forms without departing from its spirit or essential characteristics. The described embodiments are to be considered in all respects as illustrative only, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A computerized method for analyzing prospective sales leads, the method comprising:
providing a processor comprising a central processing unit programmed to fetch, decode, and execute instructions;
providing a memory comprising a computer readable storage medium operably connected to the processor to pass instructions to the processor for execution;
storing in the memory a database comprising data in modules corresponding to at least lead orders, sales leads, and reporting;
connecting the processor to the Internet to send and receive data directed to and from the database;
receiving from a user, over the Internet, lead order parameters corresponding to and defining a proposed order for a sales lead, the order parameters including at least a type of sales lead, a number of sales leads desired, at least two lead vendors from which sales leads are desired, and a geographical location; and
analyzing by the processor the order parameters.

2. The method of claim 1, further comprising:
receiving from the user, over the Internet, edited order parameters corresponding to and defining the proposed order for sales leads; and
analyzing by the processor the edited order parameters.

3. The method of claim 1, further comprising:
providing to the database, by the processor, lead evaluation data corresponding to a selected lead evaluation process, wherein the lead evaluation process comprises a pre-ping analysis, a ping analysis, and a post;
providing to the database, by the processor, lead information;
storing, by the database, lead evaluation data and lead information; and
analyzing, by the processor, the lead information in accordance with the lead evaluation data.

4. The method of claim 1, further comprising:
providing to the database, by the processor, lead dispute data corresponding to a selected lead dispute process, wherein the lead dispute process comprises a dispute basis from at least one lead vendor, submission of the dispute basis to the lead vendor, consideration of the dispute, and a result;
storing, by the database, dispute basis information for the lead vendor;
submitting, over the Internet, the dispute basis information to the lead vendor; and
receiving, over the Internet, the result from the lead vendor.

5. The method of claim 4, further comprising;
providing to the database, by the processor, lead dispute data corresponding to a selected lead dispute process, wherein the lead dispute process comprises a dispute basis from at least two lead vendors, submission of the dispute basis to the lead vendors, consideration of the dispute, and a result;
storing, by the database, dispute basis information for the lead vendors;
submitting, over the Internet, the dispute basis information to the lead vendors; and
receiving, over the Internet, the result from the lead vendors.

6. The method of claim 1, further comprising:
providing to the database, by the processor, lead disposition data corresponding to a selected lead disposition category from a group of lead disposition categories, wherein the lead disposition categories comprise successful sale and no interest;
storing, by the database, the lead disposition categories; and
receiving, over the Internet, the selected lead disposition category.

7. The method of claim 1, further comprising:
providing to the database, by the processor, lead price data corresponding to price parameters selected by at least two lead vendors, wherein the price parameters comprise a selected price over a selected amount of time;
storing, by the database, the price parameters; and
analyzing, by the processor, the price parameters.

8. The method of claim 1, further comprising:
posting the sales lead to the user using a method including at least one of electronic mail notification, direct text message notification, or notification via social media.

9. The method of claim 1, further comprising:
providing to the database, by the processor, heat map data, wherein the heat map data comprises a volume of sales leads purchased in the geographical area;
storing, by the database, the heat map data;
comparing, by the processor, the heat map data; and
displaying a graphical representation of the heat map data to the user.

10. A computerized method for analyzing prospective sales leads, the method comprising:
providing a processor comprising a central processing unit programmed to fetch, decode, and execute instructions;
providing a memory comprising a computer readable storage medium operably connected to the processor to pass instructions to the processor for execution;
storing in the memory a database comprising data in modules corresponding to at least lead orders, sales leads, and reporting;
connecting the processor to the Internet to send and receive data directed to and from the database;
receiving from a user, over the Internet, lead order parameters corresponding to and defining a proposed order for a sales lead, the order parameters including at least a type of sales lead, a number of sales leads desired, a lead vendor from which sales leads are desired, and a geographical location;
providing to the database, by the processor, lead evaluation data corresponding to a selected lead evaluation process, wherein the lead evaluation process comprises a pre-ping analysis, a ping analysis, and a post;
providing to the database, by the processor, lead information;
storing, by the database, lead evaluation data and lead information; and
analyzing, by the processor, the order parameters and the lead information in accordance with the lead evaluation data.

11. The method of claim 10, wherein the lead order parameters include at least two lead vendors.

12. The method of claim 10, further comprising:
receiving from the user, over the Internet, edited order parameters corresponding to and defining the proposed order for sales leads; and
analyzing by the processor the edited order parameters.

13. The method of claim 11, further comprising:
receiving from the user, over the Internet, edited order parameters corresponding to and defining the proposed order for sales leads; and
analyzing by the processor the edited order parameters.

14. The method of claim 10, further comprising:
providing to the database, by the processor, heat map data, wherein the heat map data comprises a volume of sales leads purchased in the geographical area;
storing, by the database, the heat map data;
comparing, by the processor, the heat map data; and
displaying a graphical representation of the heat map data to the user.

15. The method of claim 10, further comprising:
providing to the database, by the processor, lead dispute data corresponding to a selected lead dispute process, wherein the lead dispute process comprises a dispute basis from the lead vendor, submission of the dispute basis to the lead vendor, consideration of the dispute, and a result;
storing, by the database, dispute basis information for the lead vendor;
submitting, over the Internet, the dispute basis information to the lead vendor; and
receiving, over the Internet, the result from the lead vendor.

16. The method of claim 10, further comprising:
posting the sales lead to the user using a method including at least one of electronic mail notification, direct text message notification, or notification via social media.

17. A computerized method for analyzing prospective sales leads, the method comprising:
providing a processor comprising a central processing unit programmed to fetch, decode, and execute instructions;
providing a memory comprising a computer readable storage medium operably connected to the processor to pass instructions to the processor for execution;
storing in the memory a database comprising data in modules corresponding to at least lead orders, sales leads, and reporting;
connecting the processor to the Internet to send and receive data directed to and from the database;
receiving from a user, over the Internet, lead order parameters corresponding to and defining a proposed order for a sales lead, the order parameters including at least a type of sales lead, a number of sales leads desired, at least two lead vendors from which sales leads are desired, and a geographical location;
providing to the database, by the processor, lead evaluation data corresponding to a selected lead evaluation process, wherein the lead evaluation process comprises a pre-ping analysis, a ping analysis, and a post;
providing to the database, by the processor, lead information;
storing, by the database, lead evaluation data and lead information;
analyzing, by the processor, the order parameters and the lead information in accordance with the lead evaluation data; and
posting the sales lead to the user using a method including at least one of electronic mail notification, direct text message notification, or notification via social media.

18. The method of claim 17, further comprising:
receiving from the user, over the Internet, edited order parameters corresponding to and defining the proposed order for sales leads; and
analyzing by the processor the edited order parameters.

19. The method of claim 17, further comprising:
providing to the database, by the processor, lead dispute data corresponding to a selected lead dispute process, wherein the lead dispute process comprises a dispute basis from at least one lead vendor, submission of the dispute basis to the lead vendor, consideration of the dispute, and a result;
storing, by the database, dispute basis information for the lead vendor;
submitting, over the Internet, the dispute basis information to the lead vendor; and
receiving, over the Internet, the result from the lead vendor.

20. The method of claim 17, further comprising:
providing to the database, by the processor, dashboard data, wherein the dashboard data comprises numbers of sales leads the user obtains from one of the lead vendors;
storing, by the database, the dashboard data;
comparing, by the processor, the dashboard data; and
displaying a graphical representation of the dashboard data to the user.
